(19) United States
(12) Patent Application Publication
(10) Pub. No.: US 2011/0095706 A1
(43) Pub. Date: Apr. 28, 2011

(54) LIGHT FITTING AND CONTROL METHOD

(76) Inventor: Toivo Vilmi, Kiviniemi (FI)

(21) Appl. No.: 13/001,064

(22) PCT Filed: Jun. 25, 2009
(86) PCT No.: PCT/FI2009/050567

§ 371 Date: Dec. 23, 2010

(30) Foreign Application Priority Data
Jun. 27, 2008 (FI) 20085657

(51) Int. Cl. H05B 37/02

(52) U.S. Cl. 315/294

(57) ABSTRACT

A light fitting comprises at least one replaceable module (112, 114), and each module (112, 114) comprises at least one light source (106 to 110). Each module (112, 114) comprises a controller (102, 104) for compensating for a change in light intensity resulting from the aging of at least one light source (106 to 110) by adjusting the electric power to be supplied to said at least one light source (106 to 110) as a function of time in a predetermined manner.

### FIELD

The invention relates to a light fitting and to a control method.

### BACKGROUND

A light fitting comprising a plurality of lighting units, such as LEDs (Light Emitting Diode) or LED arrays may be used for illuminating interiors or outdoor locations. As an example of outdoor light fittings, streetlights may be mentioned. When a lighting unit of a light fitting is broken, it can be replaced with a new, working unit.

When a broken lighting unit is replaced with a new, working one, the new lighting unit is usually not quite similar to the original lighting unit, even if the model and type were the same. LEDs also develop rapidly and the intensities thereof continue to increase. Accordingly, the new lighting unit is usually brighter than the original was when new. In addition, intact lighting units still present in the light fitting have aged in use, and their intensity decreased. Also temperature affects the aging of a lighting unit. Even if the new lighting unit were as bright as the original lighting unit when new, the new lighting unit is, however, generally brighter than the lighting units already aged in use.

The intensity of a new lighting unit may be set to a predetermined level by measuring the intensity of the lighting unit, by comparing the intensity measured with the desired intensity and by controlling the electric power supplied to the lighting unit in such a manner that the intensity of the lighting unit settles at the desired level.

However, problems are associated with this solution. The structure of the solution is complex. In addition, the measurement of the intensity of the lighting unit is interfered with by soiling of the optical measuring sensor, ice, snow and/or interference light originating from elsewhere.

### BRIEF DESCRIPTION

The object of the invention is to provide an improved light fitting and a method. This is achieved with a light fitting comprising at least one replaceable module, and each module comprising at least one light source. Each module comprises a controller configured to compensate for a change in light intensity caused by the aging of at least one light source by adjusting the electric power to be supplied to said at least one light source as a function of time and the electric power supplied in a predetermined manner.

The invention also relates to a control method for a light fitting. A change in light intensity caused by the aging of at least one light source is compensated for by adjusting the electric power to be supplied to said at least one light source as a function of time and the electric power supplied in a predetermined manner.

Preferred embodiments of the invention are described in the dependent claims.

The method and system of the invention provide a plurality of advantages. The intensity of the light fitting can be kept as desired with a simple arrangement in spite of the replacement of a module during the entire life span of the light fitting. Soiling, ice, snow or interference light coming from elsewhere alone or together do not hinder the adjustment of intensity.

### LIST OF FIGURES

In the following, the invention will be described in more detail in connection with preferred embodiments with reference to the accompanying drawings, in which

FIG. 1 shows a light fitting,

FIG. 2 shows a light fitting illustrating the controller in more detail,

FIG. 3 shows the behaviour of the intensity as a function of time,

FIG. 4 shows electric power as a function of time,

FIG. 5 shows compensation for the intensity of a broken module,

FIG. 6 shows a switching power supply,

FIG. 7 shows the adjustment of electric power, and

FIG. 8 shows a flow diagram of the method.

### DESCRIPTION OF EMBODIMENTS

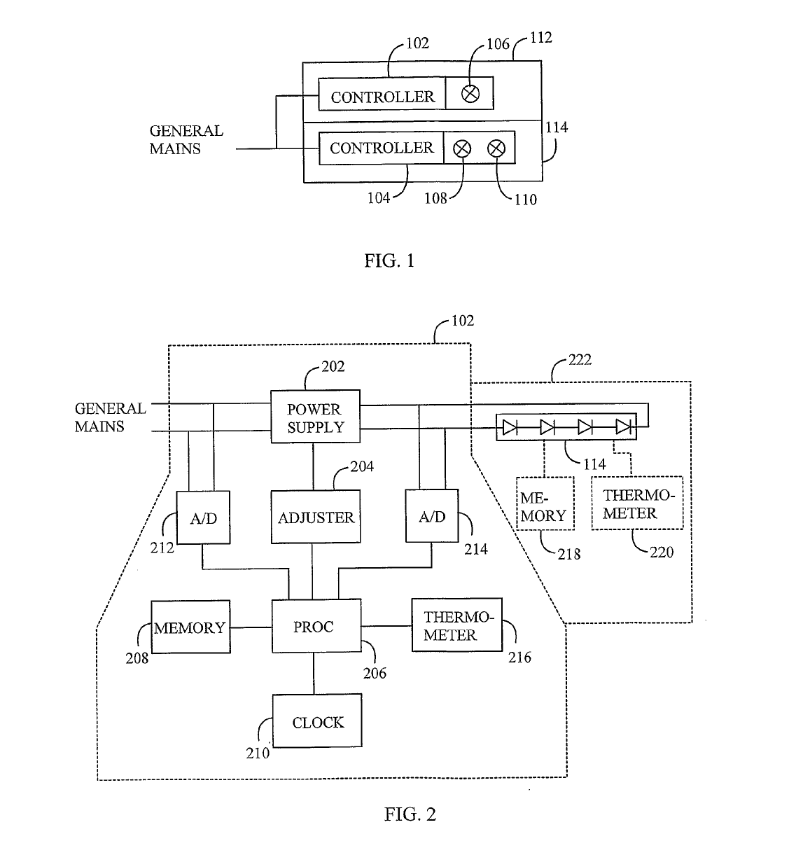

Let us now study a light fitting by means of FIG. 1. General mains, for example, may supply electric power to modules 112 and 114. Module 112 comprises one light source 106. Module 114, in turn, comprises two light sources 108 and 110. The light sources 106 to 110 may be LEDs. Generally, there may be one or more modules and each module may comprise one or more light sources. Module-specific controllers 102, 104 may convert alternating current, which may originate from general mains, into direct current, for example. Instead of general mains, the electric power may originate from a special power source of a light fitting system, a light fitting or a light source. The controllers 102, 104 may also control the electric power supplied to the modules 112, 114. The controllers 102, 104 may control the voltage level and/or the strength of the electric current supplied by modifying the impulse ratio, for example.

Each module 112, 114 may comprise a controller 102, 104 of its own, which compensates for a change in light intensity caused by the aging of module 112, 114 and/or at least one light source 106 to 110 therein by adjusting the electric power supplied to each light source 106 to 110 or module 112, 114 as a function of time in a predetermined manner.

Let us now study the solution presented by means of FIG. 2. Each controller 102, 104 may comprise a power source 202, an adjuster 204, a processor 206, memory 208 and a clock 210, In addition, each controller 102, 104 may comprise a sensor 212, a sensor 214 and a thermometer 216. The clock 210 and the thermometer 216 may also be common to the entire light fitting. The clock may also be module-specific. The thermometer 220, in turn, may be module-specific or light source-specific. Instead the actual temperature, a threshold voltage, which is a function of temperature, may be measured from the LEDs serving as light sources. This allows the temperature to be measured without a separate thermometer.

Furthermore, the memory 218, which may serve as an escort memory, may be module-specific, whereby the reparation data and/or stress data corresponding to the data stored in the memory 208 may be stored in the memory 218 of each module. Data may be written into the memory 218 and the data in the memory 218 may be read through power supply conductors.

The memory 218 and at least one LED serving as a light source 106 to 110 may be integrated into one replaceable light fitting component 222. The component 222 may comprise one or more electric circuits, which may be semiconductor chips. The component 222 may also include only one semiconductor chip, into which the memory 218 and at least one light source 106 to 110 are integrated. The component 222 may also comprise a thermometer 220, which measures the temperature directly or by means of the threshold voltage.

The clock 210 may measure the time during which each light source 106 to 110 or module 112, 114 has been in use for adjusting the electric power supplied. The clock 210 may measure the time during which electric power or each electric power range has been connected to at least one light source 106 to 110 or module 112, 114.

Let us assume at first that the light fitting is to illuminate with a constant intensity. Let us study module 114, but the same applies also generally to the adjustment of modules. The processor 206 ay control the adjuster 204 to alter the supply of electric power of the power source 202 to module 114 as a function of time by means of the data stored in the memory 208, 218 about the behaviour of the illumination intensity of the light sources with respect to time. Generally, the intensity of the light sources decreases as a function of time, so that the a microprocessor 206 may control the adjuster 204 to supply more electric power to the module 114 for keeping the intensity constant. The sensor 214, in turn, may measure the electric power supplied to light source 106, such as the magnitude of the electric current, and input the data in the processor 206. In this manner, the processor 206 may compare if the electric power actually supplied to the module 114 is exactly of the magnitude that the microprocessor 206 intended it to be.

If the light sources 106 to 110 are controlled by modules 112, 114, each module 112, 114 may have a predetermined light intensity level of 600 lm, for example. This being so, the electric current consumed may be about 1.5 A, for example. However, this electric current (and thus power) changes because of aging.

Each processor 206 may adjust the change in light intensity based on the duration of the electric power range. Electric power may be approximated into one or more power ranges. Accordingly, if about 1.5 A of electrical current was supplied to module 112, 114, the case may be that for instance after each 6 700 hours, the light intensity of module 112, 114 decreases by 10%. If a 10% decrease in light intensity corresponds to a deviation value, a change of the size of which or exceeding it must not occur in light intensity, an adjustment of the light intensity is performed. In this case, the processor 206 may supply for instance a 10% higher electric current to module 112, 114 after each 6 700 hours. Along with aging, the change may slow down or speed up as a function of time. In this case, after the first 6 700 hours, the electric power may require a 10-% increase, but the following 10% may be required only after 10 000 hours or already after 5 000 hours. No matter how the light intensity changes, data may, however, be stored in the memory 208, 218, about how much the supply of electric power is increased into each module after a predetermined time.

The power range supplied by the power source 202 may also be changed. In this case, the voltage level or the strength level of the electric current may be adaptive. Each processor 206 may set the electric power range to be supplied to each light source or module and adjust it as a function of time based on the electric power range set. If light sources 106 to 110 are controlled by modules 112, 114, each module 112, 114 may have for instance two light intensity levels, which may be 400 lm and 800 lm, for example. At the lower intensity level, the electric power is lower (e.g. electric current is about 1 A) and at the higher intensity level, the electric power is higher (e.g. electric current is about 2 A). Each processor 206 may control each module to the desired intensity level by setting the desired power range, the power according to which is supplied to each module. Aging and the decrease in light intensity are generally faster at a higher intensity level because of a higher consumption of electric power, a higher temperature or the like. The power supplied may also be measured with the sensor 214 and the data input in the processor 206.

Each processor 206 may compensate for the change in light intensity based on the time of duration of each electric power range. Accordingly, if an about 1-A electric current is supplied to module 112, 114, the case may be that for instance after every 10 000 hours, the light intensity of module 112, 114 decreases by 10%. If a 10-% (or a fixed 40 lm) decrease in light intensity corresponds to a deviation value, a change of the size of which or exceeding which must not occur in light intensity, an adjustment of the light intensity is performed. In this case, an about 10% higher electric current may be supplied to module 112, 114 after every 1 000 hours. Along with aging, the change may slow down or speed up. No matter how the light intensity changes, data may, however, be stored in the memory 208, 218, about how much the supply of electric power is increased into each module after a predetermined time.

Correspondingly, if an about 2-A electric current is supplied to module 112, 114, the case may be that the light intensity of module 112, 114 is decreased by 10% after each 5 000 hours, for example. If also in this example, a 10-% (or a fixed 80 lm) decrease in light intensity corresponds to a deviation value, a change of the size of which or exceeding which must not occur in light intensity, an adjustment of the light intensity is performed. In this case, an about 10% higher electric current may be supplied to module 112, 114 after every 5 000 hours. In a manner similar to what was described above, along with aging, the change may slow down or speed up, but no matter how the light intensity changes, data may, however, be stored in the memory 208, 218, about how much the supply of electric power is increased into each module after a predetermined time.

Generally, the controller 102, 104 may determine the intensity deviation d of at least one light source 106 to 110 and/or module from the desired intensity as a function of the electric power p supplied and time t. This may be expressed mathematically as d=f(p, t). Function f may be the product between power and time, for example. In this case, the predetermined deviation value may be 10 000 Ah, which corresponds to the 10-% decrease in the previous example (1A×10 000 h=2A×5 000 h≈1.5A×6 700 h).

If temperature T is also taken into account, deviation d may be expressed as function k≧d=f(p, t, T). In both cases, function f is a function increasing with respect to power and time (and temperature). Function f may also include a constant term ref such that f(p, t, T)=ref−g(p, t, T), wherein ref signifies the desired light intensity and g(p, t, T) signifies the actual intensity. In this case, deviation d indicates the difference between the desired intensity and the actual intensity. Instead of the difference, ratio f(p, t, T)=ref/g(p, t, T) may also be established. The intensity is adjusted if deviation d equals or exceeds a predetermined deviation value k.

The light intensity of module 112, 114 or each light source 106 to 110 may be adjusted if function f is e.g. the sum

$${\sum }_{i = 1}^{N} {p}_{i} \cdot {t}_{i} = d \geq k ,$$

wherein i is the index of the sum (the index of the power range), N is the number of summed items (e.g. number of power ranges), pᵢ is weight coefficient of time, tᵢ is time used in power range i, and k is deviation value. Weight coefficient pᵢ may represent the power range. If the clock is a counter that counts pulses, the weight coefficient pᵢ may be used to multiply the number of pulses or the pulse frequency. The controller 102, 104 may determine deviation d. The predetermined deviation value k is stored in the memory 208, 218. The processor 206 may calculate the values of both functions f and g or retrieve them from the memory 208, 218, wherein they may have been stored as predetermined values.

In addition or alternatively, each controller 102, 104 may measure the temperature of each light source 106 to 110 and adjust the electric power supplied thereto as a function of time based on the temperature measured. Sometimes, module 112, 114 may be at a temperature of 50° C. and at another time at a temperature of 80° C., for example. Aging and decrease in light intensity are faster at a higher temperature.

Each controller 102, 104 may compensate for the change in light intensity based on the duration in time of each temperature. In this case, the thermometer 216 may measure the temperature of the light fitting and/or the environment. Accordingly, if the temperature of module 112, 114 has been 50° C. for 10 000 hours, the light intensity of module 112, 114 may decrease by 10%. If again the temperature of module 112, 114 has been 80° C. for 5 000 hours, the light intensity of module 112, 114 may also decrease by 10%. If a 10-% decrease in the light intensity corresponds to deviation value k, a change of the size of which or exceeding which must not occur in the light intensity, an adjustment of the light intensity is performed. In this case, for instance a 10% higher electric current may be supplied to module 112, 114 after each 1 000 hours spent at a temperature of 50° C. Correspondingly, for instance a 10% higher electric current may be supplied to module 112, 114 after each 6 250 hours spent at a temperature of 80° C. And, as was previously stated, along with aging, the change in light intensity may slow down or speed up, but no matter how the light intensity changes, data may, however, be stored in the memory 208, 218, about how much the supply of electric power is increased into each module after a predetermined time.

One or more predetermined deviation values may be stored in each controller 102, 104. The controller 102, 104 may determine the deviation of the intensity of said at least one light source 106 to 110 from the desired intensity as a function of the electric power supplied to said at least one light source 106 to 110 and time. Each controller 102, 104 may adjust the electric power to be supplied to said at least one light source 106 to 110 when the deviation exceeds the predetermined deviation value k. Data about the change in light intensity may be stored in the memory 208, 218 at the manufacturing stage of module 112, 114. The predetermined deviation value k may be of a different magnitude at the different intensity levels.

Actions associated with the compensation of the fading intensity due to aging may be performed in real time or they may be performed at prescribed times, at intervals of 1 000 hours, for example. In real-time operation, measurements and power supply change requirements are determined at all times. When operating at prescribed times, the controller 102, 104 may collect power level data and/or temperature data during 1 000 hours, for example, and then determine at intervals at 1 000 hours if there is need to change the power supply to the light sources. Instead of 1 000 hours, any prescribed time found suitable may be selected for performing the actions.

The data stored in the memory 208, 218 may be based on the likely development of the intensity determined by means of measurements performed in advance. The data stored in the memory 208, 218 may be based on data measured and/or given by the manufacturer of the light sources or measurements of the manufacturer of the module.

A signal including data about a module installed may be transmitted over general mains or another power supply network associated with the light fittings for modifying the data stored in the memory 208, 218. The data may have been obtained by measuring light source 106 to 110 and module 112, 114 individually in advance, or the data may be based on data obtained from the manufacturer. The sensor 212 may receive the signal and transfer the data included in the signal to the processor 206, which may store the data included in the signal in the memory 208, 218. A signal associated with a new lighting unit may comprise interpretation data for a control signal received and data about the behaviour of new light sources with respect to time and temperature. In addition, the data may determine the electrical control of a new light source or module. In this manner, the processor 206 is able to control the adjuster 204 to adjust the power source 202 to supply the right kind of electric power in the desired power range to a newly replaced module, for example. The electric power may also be adjusted with the processor 206, the adjuster 204 and the power source 202 according to data stored in the memory 206, 218. When required, the data in the memory 208, 218 may be further modified with the control signal. In addition, the memory 208, 218 may include for instance a suitable computer program, interpretation data for a control signal received and data about the behaviour of light sources with respect to time and temperature.

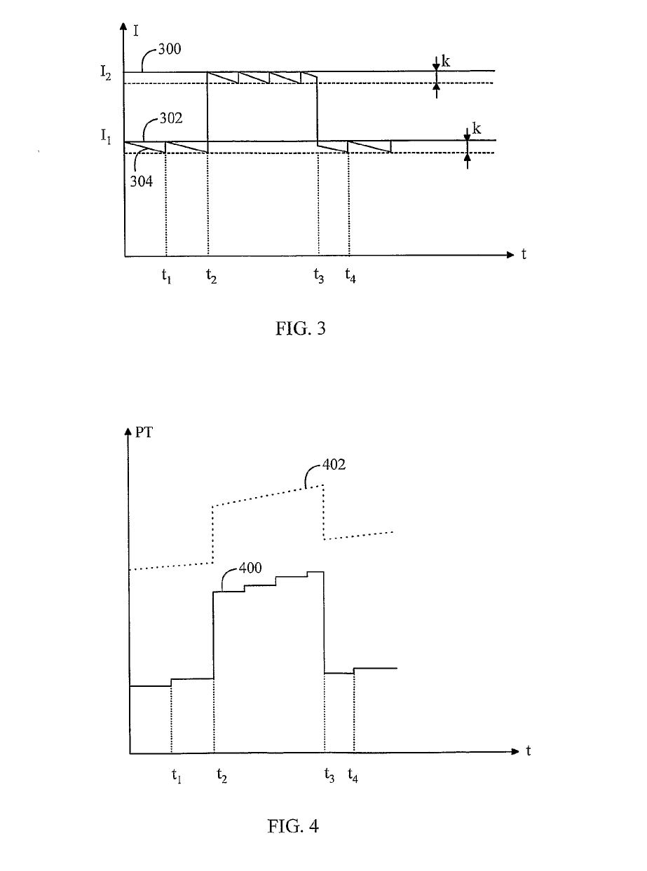

FIG. 3 shows the adjustment of light intensity as a function of aging. The vertical axis is light intensity I and the horizontal axis is time. Both axes are on a freely selected linear scale. Line 300 represents a first desired intensity level I₁, and line 302 represents a second desired intensity level I₂. When a module (an individual light source may be involved, too) starts to illuminate at time 0, electric power is supplied thereto in an amount making it illuminate at the desired intensity level 302. However, aging makes the actual intensity 304 of the module decrease when the electric power remains constant. When time has lapsed up to time t₁, the deviation of the actual intensity 304 from the desired intensity 302 has increased to the magnitude of a predetermined deviation value k, and the intensity is adjusted, whereby the actual intensity 304 becomes (approximately) equal to the desired intensity 302.

At time t₂, the actual intensity 304 is modified to correspond to the desired intensity level 300. Since the desired intensity level 300 is higher than the desired intensity level 302, the consumption of electric power is also higher at the desired intensity level 300. For this reason, also aging is faster (the angular coefficient of the decreasing part of the actual intensity is higher), and adjustments have to be made more frequently.

At time t₃, after the actual intensity 304 has fallen, but less than is required for an adjustment, the actual intensity 304 is calculated back to the level of the desired intensity 300. However, the actual intensity 304 may remain slightly below the desired intensity 300, since no adjustment was made at the level of the desired intensity 302. However, an adjustment follows at time t₄. The predetermined deviation value k may be of a different magnitude at the different intensity levels.

FIG. 4 shows the power supplied to a module or a light source as a function of time. The vertical axis is energy E (i.e. the product of power and time E=pt), and the horizontal axis is time. Curve 400 represents the energy of the module or the light source. Up to time t₃, the electric power range is kept unchanged, although adjustments due to aging are made at times t₁ and t₂. At time t₃, the power range is raised higher, after which adjustments have to be made more frequently at times t₄ and t₅ as the larger power range speeds up the aging.

FIGS. 3 and 4 show adjustments of electric power as step-like increments. However, if adjustments are performed continuously (i.e. deviation value k approaches zero), the step-like property disappears from the curves of FIG. 3 and the actual intensity closely follows the desired value. The curve of FIG. 4, in turn, changes into a continuously increasing function, shown by dashed line 402. In this case, a possible step-like change is at t₂ and t₃ of the change in the power range.

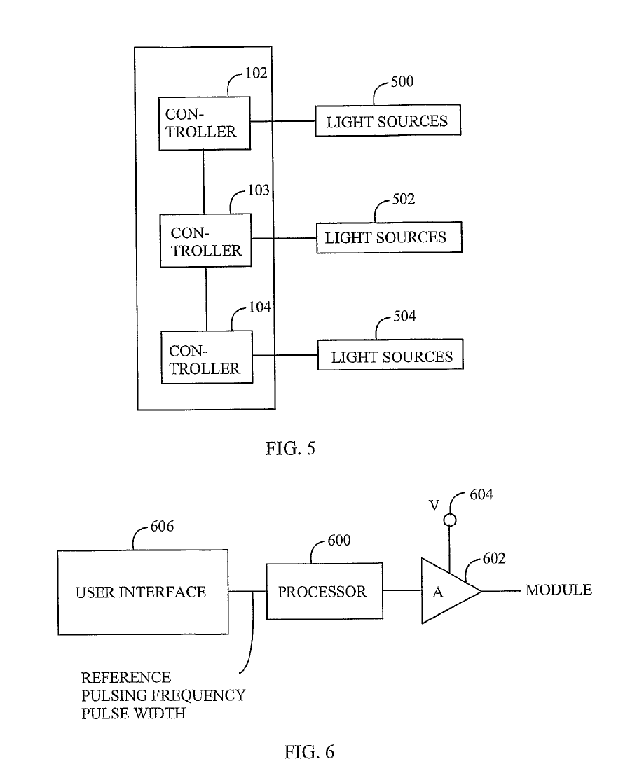

FIG. 5 shows an embodiment wherein the weakening of the light intensity caused by a broken module is compensated for by increasing the light intensity of the other modules. Controllers 102, 103 and 104 are connected to light source arrays 500, 502, 504 each including at least one light source, such as a LED. The light source array may be a module or an array independent of modules. For example, when light source array 500 is broken, controller 102 detects the breakage. The detection may be based for instance on the fact that light source array 500 no longer consumes electric power, which may be measured by current measurement, for example. Accordingly, if controller 102 measures that the strength of the electric current in the electrical circuit of light source array 500 is below a predetermined threshold value, controller 102 determines that light source array 500 is broken. Controller 102 signals the breakage to the other controllers 103, 104, which control more electric power to light source arrays 502, 502 having obtained information about the breakage. The increase in electric power may correspond to such an increase in light intensity which corresponds to the light intensity of the broken light source array 500 or an intensity close to it. The increased electric power in light source arrays 502 and 504 renders the need to adjust the compensation thereof due to aging more frequent.

FIG. 6 shows a switching power supply that controller 102, 103, 104 may comprise. In this case, the electrical drive power of module 112 may be pulsed, i.e. the electrical current may arrive at module 112 as pulses, for example. Pulsing may also be filtered into direct current before it is supplied to the module. The switching power supply 600 may comprise a programmable source 600 and an amplifier 604. The programmable source 600 may be a processor, for example. The programmable source 600 may receive a reference that determines the highest pulse height at the output of amplifier 602. The supply of electric power to module 112 may be adjusted by modifying the reference.

The programmable source 600 may also receive pulse width information associated with the electrical drive power and determining the pulse width at the output of the amplifier 602. The supply of electric power to module 112 may be adjusted by modifying the pulse width information.

The programmable source 600 may also receive pulse frequency information associated with the electrical drive power and determining the pulse frequency width at the output of the amplifier 602. The supply of electric power to module 112 may be adjusted by modifying the pulse frequency, if the pulse width is kept constant. The amplifier 602 supplies electric power, which it takes from a drive electricity pole 604, to one or more light sources controlled by the programmable source 600. The drive electricity pole 604 may include pulsed drive electric power or direct current power, which is predetermined by the drive voltage and which may be generated at the power supply 202 from alternating current.

The reference, the pulse width information and the pulse frequency information may be input in the programmable source 600 by means of a user interface 606, which may be a keyboard, a touch screen, a microphone or the like.

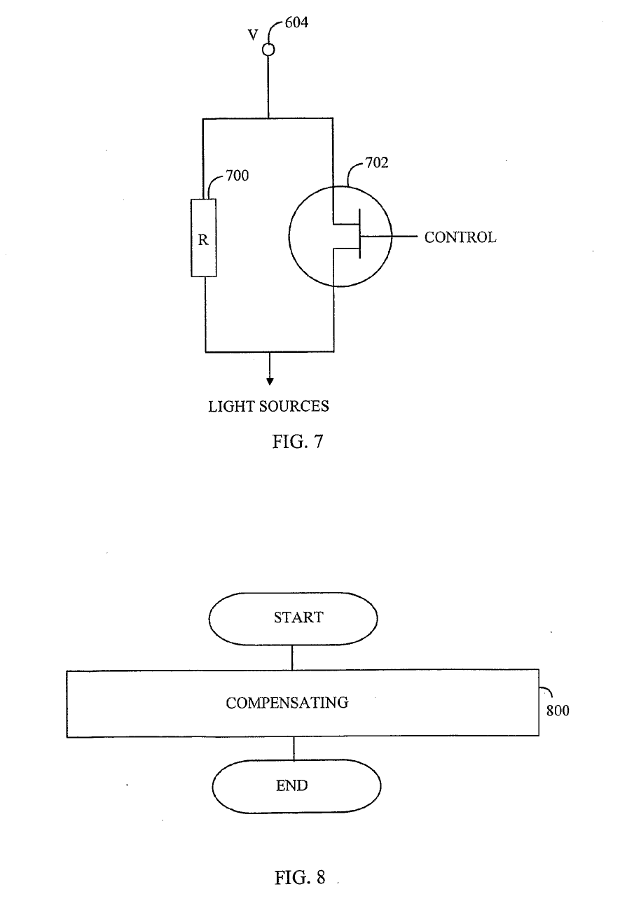

FIG. 7 shows at least part of the power source 202 and/or amplifier 602, with which the electric power supplied to the light sources is adjusted. A constant-value parallel connection of a resistor 700 and an adjustable resistor 702 may be connected in series with the drive electricity pole 604 and at least one light source. The adjustable resistor 702 may be a FET transistor (Field Effect Transistor), for example. When the resistance (conductivity of electric current) of the adjustable resistor 702 is altered, the resistance of the parallel connection also changes. When the resistance of the adjustable resistor 702 is low (lower than the value of resistor 700), a large amount of electric current may flow to the light sources. When the resistance of the adjustable resistor 702 is high (much higher than the value of resistor 700), the resistance produced by the parallel connection is equal to the value of the resistor 700. The value of the adjustable resistor 702 may be changed with the gate voltage of the FET transistor, which controller 206 and/or 600 may possibly adjust together with the adjuster 204.

Deviating from FIG. 7, the constant-value resistor 700 and the adjustable resistor 702 may also be connected in series, whereby the constant-value resistor 700 determines the maximum electric power to the light sources.

Still deviating from FIG. 7, the constant-value resistor 700 is not necessarily required at all, but the adjustable resistor 702 may adjust the electric power to the light sources without the upper or lower limit determined by the constant-value resistor 700.

FIG. 8 shows a flow diagram of the method. In step 800, a change in the light intensity resulting from the aging of at least one light source 106 to 110 is compensated for with the controller 102, 104 in each module 112, 114 by adjusting the electric power supplied to said at least one light source 106 to 110 as a function of time in a predetermined manner.

The controller 102 to 104 may change the electric power supplied to at least one light source 106 to 110 also as a function of a momentary temperature. The case is generally that the higher the temperature at which a light source is, the lower is the intensity it illuminates with. Accordingly, at a high temperature, more electric power may have to be supplied to a light source than at a low temperature for keeping the light intensity constant, for example.

Although the invention is described herein with reference to the example in accordance with the accompanying drawings, it will be appreciated that the invention is not to be so limited, but may be modified in a variety of ways within the scope of the appended claims.

1.-29. (canceled)

30. A light fitting comprising at least one replaceable module, and each module comprising at least one light source, wherein each module comprises a controller configured to adjust, in a predetermined manner, the electric power to be supplied to said at least one light source as a function of both time and the electric power supplied for a change in light intensity caused by the aging of at least one light source.

31. A light fitting as claimed in claim 30, wherein one or more predetermined deviation values are stored in each controller, the controller is configured to determine the deviation of the intensity of said at least one light source from a desired intensity as a function of the electric power supplied to said at least one light source and time, and each controller is adapted to adjust the electric power to be supplied to said at least one light source when the deviation exceeds each predetermined deviation value.

32. A light fitting as claimed in claim 31, wherein stored data is based on measurement by the manufacturer of the light source or a measurement or information given by the manufacturer of the light fitting.

33. A light fitting as claimed in claim 30, wherein each controller is configured to set the electric power to be supplied to said at least one light source to a desired power range and to adjust the electric power to be supplied to said at least one light source based on the time of duration of the electric power range set.

34. A light fitting as claimed in claim 33, wherein each controller is configured to feed said at least one light source at a plurality of power ranges and to adjust a change in light intensity based on the time of duration of each power range.

35. A light fitting as claimed in claim 30, wherein the controller is configured determine the temperature of at least one light source and to adjust the electric power to be supplied to said at least one light source based on the time of duration of the temperature measured.

36. A light fitting as claimed in claim 35, wherein each controller is configured to determine the temperature as predetermined temperature ranges and to adjust a change in light intensity based on the time of duration of each temperature range.

37. A light fitting as claimed in claim 30, wherein each light source is a LED.

38. A light fitting as claimed in claim 30, wherein the light fitting comprises at least one clock configured to measure the time for adjusting the electric power to be supplied to said at least one light source.

39. A light fitting as claimed in claim 30, wherein the clock is configured to measure the time during which the supply of electric power is connected to said at least one light source.

40. A light fitting as claimed in claim 30, wherein the controller is configured to change the electric power to be supplied to at least one light source as a function of the temperature for adjusting the light intensity.

41. A light fitting as claimed in claim 30, wherein the light fitting comprises at least one integrated component comprising at least one light source and a memory, in which data is stored for adjusting the electric power to be supplied to said at least one light source a function of time in a predetermined manner.

42. A light fitting as claimed in claim 41, wherein the integrated component comprises one semiconductor chip.

43. A light fitting as claimed in claim 30, wherein when the light sources of a module are broken, the controller of at least one other module is configured to increase the electric power to the light sources.

44. A light fitting as claimed in claim 30, wherein the controller comprises a programmable source and an amplifier, the programmable source is configured to receive a reference and to control the amplifier to supply electric power to at least one light source based on the reference.

45. A control method for a light fitting, the method comprising compensating for a change in light intensity caused by the aging of at least one light source with a controller in each module by adjusting, in a predetermined manner, the electric power to be supplied to said at least one light source as a function of both time and the electric power supplied.

46. A method as claimed in claim 45, the method further comprising by determining the deviation in the intensity of said at least one light source from the desired intensity with each controller as a function of the electric power supplied to said at least one light source and time, and adjusting the electric power supplied to said at least one light source by a predetermined amount when the deviation exceeds at least one predetermined deviation value.

47. A method as claimed in claim 46, wherein the predetermined deviation value is based on a measurement by the manufacturer of the light source or on a measurement or information given by the manufacturer of the light fitting.

48. A method as claimed in claim 45, the method further comprising setting, with each controller, the electric power to be supplied to said at least one light source to the desired power range and adjusting the electric power to be supplied to said at least one light source based on the duration in time of the electric power range set.

49. A method as claimed in claim 48, the method further comprising feeding, with each controller, said at least one light source at a plurality of power ranges and adjusting a change in the light intensity based on the duration in time of each power range.

50. A method as claimed in claim 45, the method further comprising by measuring the temperature of said at least one light source, and adjusting the electric power to be supplied to said at least one light source based on the duration in time of the temperature measured.

51. A method as claimed in claim 50, the method further comprising determining the temperature as predetermined temperature ranges and adjusting the change in light intensity based on the duration in time of each temperature range.

52. A method as claimed in claim 45, wherein each light source is a LED.

53. A method as claimed in claim 45, the method further comprising measuring time with a clock for adjusting the electric power to be supplied to at least one light source.

54. A method as claimed in claim 53, the method further comprising measuring the time during which the supply of electric power is connected to said at least one light source.

55. A method as claimed in claim 45, the method further comprising modifying the electric power to be supplied to at least one light source as a function of temperature for adjusting the light intensity.

56. A method as claimed in claim 45, wherein the light fitting comprises at least one integrated component comprising at least one light source and a memory in which data is stored, which is used to adjust the electric power to be supplied to at least one light source as a function of time in a predetermined manner

57. A method as claimed in claim 45, the method further comprising increasing the electric power of at least one light source of at least one other module when the light sources of a module are broken.

58. A method as claimed in claim 45, wherein the controller comprises a programmable source and an amplifier, a reference is received in the programmable source, and the amplifier is controlled to supply electric power to at least one light source based on the reference.
